(19) United States
(12) Patent Application Publication
(10) Pub. No.: US 2018/0068159 A1
(43) Pub. Date: Mar. 8, 2018

(54) METHOD OF SECURING A FINGERPRINT SENSOR ONTO A COVER MEMBER INCORPORATED WITHIN A HOST DEVICE PANEL

(71) Applicant: IDEX ASA, Fornebu (NO)

(72) Inventors: FRED G. BENKLEY, III, Andover, MA (US); DAVID JOSEPH GEOFFROY, Amherst, MA (US); DAVID N. LIGHT, LOS GATOS, CA (US)

(73) Assignee: IDEX ASA, FORNEBU (NO)

(21) Appl. No.: 15/693,882

(22) Filed: Sep. 1, 2017

Related U.S. Application Data
(60) Provisional application No. 62/382,864, filed on Sep. 2, 2016.

(51) Int. Cl. G06K 9/00; B29C 65/48; B29C 65/66; B29C 65/00

(52) U.S. Cl. CPC G06K 9/00013; B29C 65/4845; G06F 1/1637; B29C 66/7465; B29C 65/665

(57) ABSTRACT

A method of securing a fingerprint sensor into a host device panel comprises, in one embodiment, securing a cover panel to the fingerprint sensor assembly and then securing the covered fingerprint sensor into a hole formed in the host device panel. In another embodiment, the cover panel is secured within a hole formed in the host device panel, and then the host device panel is placed over the fingerprint sensor assembly with the cover member aligned with the sensor assembly.

### CROSS REFERENCE

This application claims the benefit under 35 U.S.C. § 119(e) of the filing date of provisional patent application Ser. No. 62/382,864 filed Sep. 2, 2016, the disclosure of which is incorporated herein by reference.

### BACKGROUND

Today's mobile devices, smart phones, electronic books, tablet computers, and laptop computers (generically referred to herein as “host devices”) typically include a host device panel that comprises a large areas of glass (i.e., a glass panel) constituting a surface of the device. The host device panel may comprise a display device and/or an input device (e.g., a touch screen). Many manufacturers of such devices are keen to incorporate fingerprint sensors into those devices to facilitate user authentication and access to the device. Capacitive fingerprint sensors offer a cost-effective solution. Thermal, ultrasonic or optical fingerprint sensors are alternative solutions.

Fingerprint sensors may not perform well if placed under glass panels of the type typically used in host devices. Glass that provides the necessary mechanical robustness required for a portable, practical consumer device may be too thick and/or may have chemical properties that are not necessarily optimal for the fingerprint sensor to meet specified acceptance/rejection rates.

Some manufacturers have used a dedicated cover member that covers the fingerprint sensor only, such as a sapphire window. The host device panel of the host device fits around the dedicated sapphire window. Sapphire is very expensive, however, and therefore increases material costs of the host device substantially.

Another existing solution is to take a glass host device panel and then etch away an area that will cover the fingerprint sensor to locally “thin” that portion of the panel. However, this adversely affects the strength of the glass panel, and the process is costly and difficult to control. It is also difficult to get this thinned region of glass thin enough to prevent excessive degradation of the fingerprint image, both in terms of signal to noise ratio (“SNR”) and blurring, and the transition area from thin to thick glass is a stress concentrator, thereby jeopardizing the robustness of the glass panel.

The present applicant has developed a fingerprint sensor that will operate well behind a cover member made of glass, such as strengthened, boroaluminosilicate glass, rather than sapphire, and furthermore is able to meet mechanical robustness requirements such as drop tests, shock and vibration tests, ball drop tests, tumble tests, etc.

This disclosure describes practical manufacturing methods of incorporating such a fingerprint sensor into a mobile device.

U.S. Provisional Application Nos. 62/258,284; 62/349,256; and 62/374,339, “Electronic Sensor Supported on Rigid Substrate,” and U.S. Patent Application Publication No. 2017/0147852 claiming priority thereto, the respective disclosures of which are hereby incorporated by reference, describe “wrapped sensor” designs covered with a glass cover member. Such wrapped sensor designs comprise a rigid substrate wrapped in a flexible circuit subassembly comprising conductive trace sensor elements, a circuit element such as an integrated circuit or application specific integrated circuit (“ASIC”), and conductive interconnects connecting the sensor elements to the circuit element all disposed on a flexible substrate material.

U.S. Provisional Application No. 62/354,210, “Reinforcement Panel for Fingerprint Sensor Cover” and U.S. patent application Ser. No. 15/628,003 claiming priority thereto, the respective disclosures of which are hereby incorporated by reference, describe “wrapped sensor” designs covered with glass cover members reinforced with a ceramic layer to aid robustness.

For reasons of electrical performance of the sensor, the thickness of the glass used for the cover member may be substantially less than that of the host device panel, and it may be made from a different specific glass compound as the glass of the host device panel. The glass cover member for the sensor could be provided by the same or different supplier as the host device panel.

A wrapped sensor can be covered by a glass cover member and then incorporated into host device panel, such as a glass display/interface panel of a mobile device. Pre-cut glass cover members can be adhered or otherwise attached to a fingerprint sensor, including, but not limited to, a wrapped sensor to create a “covered sensor assembly”. Original device manufacturers (“ODMs”) may fit the covered sensor assembly into the mobile device and integrate it into a host device display/touch panel (cover glass), by inserting it into a through opening in the host device panel, and attaching it by means of adhesive, molding compound, or other means. The surface of the covered sensor assembly could be flush mounted (coplanar with the host device panel surface), or recessed from the host device panel surface, or located proud of the host device panel surface. See FIG. 10, which shows a flush mount and a recessed mount.

Alternatively, for reasons of ease of manufacturing, supply chain efficiency, cost effectiveness, and mechanical performance, it may be more practical and more effective to fit the glass cover member into the host device panel first, in an optimal fashion, and then adhere the fingerprint sensor to it.

### BRIEF DESCRIPTION OF THE DRAWINGS

The accompanying drawings, which are incorporated herein and form part of the specification, illustrate various embodiments of the subject matter of this disclosure.

FIG. 1 illustrates a fingerprint sensor assembly installed into a host device panel with a cover glass fitted over the sensor assembly.

FIG. 2 illustrates a fingerprint sensor assembly installed into a host device panel with a cover glass incorporated into the host device panel.

FIGS. 3 and 4 illustrate alternate embodiments in which the cover member comprises a glass strip that is bonded edge-to-edge with the host device panel.

FIGS. 3A and 4A are cross-sections of the arrangements of FIGS. 3 and 4, respectively, showing a supporting structure for the glass strip.

FIG. 5 shows a plan view and a transverse cross section of a molded glass cover.

FIG. 6A illustrates a molded cover member and a host device panel with a hole for receiving the molded cover member.

FIG. 6B is a transverse cross-section of the molded cover member installed in the host device panel.

FIG. 7 is a transverse cross-section of the molded cover member and fingerprint sensor assembly installed in the host device panel.

FIG. 8 is a flow chart showing steps of the process schematically illustrated in FIGS. 5-7.

FIG. 9 is a plan view of a smart phone (host device) panel in which a fingerprint sensor and associated cover member are mounted into an inactive area of the smart phone.

FIG. 9A is an enlarged cross-section of a portion of FIG. 9.

FIGS. 10A and 10B show a flush mount and a recessed mount, respectively, of a molded cover member with respect to a host device panel.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

This description may use relative spatial and/or orientation terms in describing the position and/or orientation of a component, apparatus, location, feature, or a portion thereof. Unless specifically stated, or otherwise dictated by the context of the description, such terms, including, without limitation, top, bottom, above, below, under, on top of, upper, lower, left of, right of, in front of, behind, next to, adjacent, between, horizontal, vertical, diagonal, longitudinal, transverse, radial, axial, etc., are used for convenience in referring to such component, apparatus, location, feature, or a portion thereof in the drawings and are not intended to be limiting.

Furthermore, unless otherwise stated, any specific dimensions mentioned in this description are merely representative of an exemplary implementation of a device embodying aspects of the disclosure and are not intended to be limiting.

The use of the term “about” applies to all numeric values specified herein, whether or not explicitly indicated. This term generally refers to a range of numbers that one of ordinary skill in the art would consider as a reasonable amount of deviation to the recited numeric values (i.e., having the equivalent function or result) in the context of the present disclosure. For example, and not intended to be limiting, this term can be construed as including a deviation of ±10 percent of the given numeric value provided such a deviation does not alter the end function or result of the value. Therefore, under some circumstances as would be appreciated by one of ordinary skill in the art a value of about 1% can be construed to be a range from 0.9% to 1.1%.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as well as instances in which the event, circumstance, characteristic, or property occurs to a close approximation, such as accounting for typical tolerance levels or variability of the embodiments described herein.

As used herein, the terms “optional” and “optionally” mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

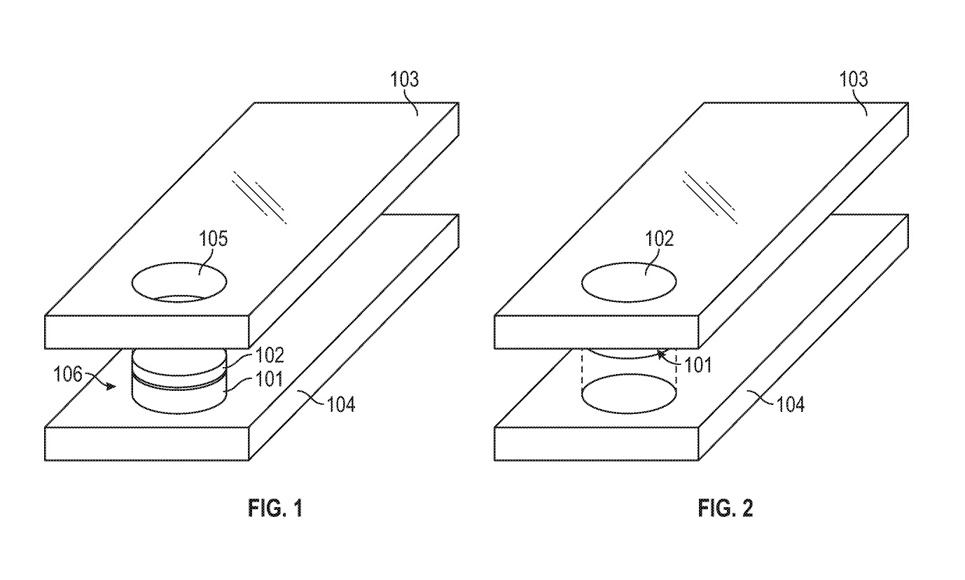

Components and steps employed in one method of installing a covered fingerprint sensor assembly into a host device panel are described below with reference to FIG. 1:

A fingerprint sensor assembly 101 is provided. Suitable fingerprint sensor assemblies include, but are not limited to, those described in U.S. Patent Application Publication No. 2017/0147852 and U.S. patent application Ser. No. 15/628,003.

Optionally, the fingerprint sensor assembly 101 is incorporated into a pre-manufactured spacer frame (not shown) edgewise surrounding the fingerprint sensor assembly as described, for example, in U.S. Patent Application Publication No. 2017/0147852.

Optionally, a suitable reinforcement panel (not shown) is adhered to the surface of the fingerprint sensor assembly 101 and/or to a cover member covering the fingerprint sensor assembly as described, for example, in U.S. patent application Ser. No. 15/628,003.

A suitable glass cover member 102 is tightly adhered to the surface of the fingerprint sensor assembly 101 (or reinforcement panel), for example, in a manner described in U.S. Patent Application Publication No. 2017/0147852 and U.S. patent application Ser. No. 15/628,003, to create a covered fingerprint sensor assembly 106. The host device panel 103 has a hole 105 of appropriate dimensions and position to receive the covered fingerprint sensor assembly 106. The glass cover member 102 may be a different thickness than the host device panel 103 and may be a different type of glass in terms of its physical properties, color, roughness, dielectric, etc. Exemplary dimensions are set forth below. Alternatively, the cover member 102 may comprise a material other than glass. In one embodiment, the cover member 102 is made of a material having a similar coefficient of thermal expansion as the material of the host device panel 103.

The covered fingerprint sensor assembly 106 is fitted into or mounted to the host device 104, appropriate I/O connections are made between the fingerprint sensor assembly 101 and the host device 104, and the host device panel 103 is fitted on top of the host device 104 with the covered fingerprint sensor assembly 106 fitting into the hole 105. In an embodiment, the glass used for the host device panel 103 is strengthened glass of appropriate thickness and properties required to meet mechanical robustness requirements, such as 0.55 mm to 0.7 mm Corning Gorilla® Glass. There are at least two options to securing the covered fingerprint sensor assembly 106 within the hole 105 in the host device panel:

(1) The covered fingerprint sensor assembly 106 is molded directly into place into the hole 105 formed in the host device panel 103; or

(2) dispensed (epoxy) adhesive is used to fill a gap between the perimeter of the hole 105 and the cover member 102 to bond the cover member 102 to the host device panel 103.

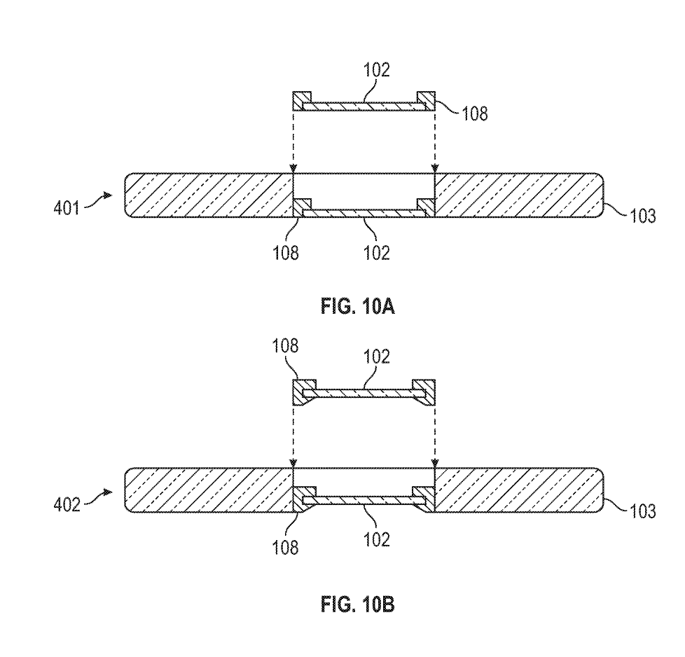

When in place, the covered fingerprint sensor assembly 106 may be flush with, recessed below, or projecting above the surface of the host device panel 103. See FIGS. 10A and 10B, which show a flush mount 401 of the cover member 102 and molding compound 108 and a recessed mount 402 of the cover member 102 and molding compound 108, respectively (the cover member 102 and molding compound 108 are shown both before and after mounting in FIGS. 10A and 10B). In some embodiments, the installed covered fingerprint sensor assembly 106 can be physically depressed like a button to provide switching functions, or alternatively, the covered fingerprint sensor assembly 106 may be fixed in place whereby it cannot physically move.

Components and steps employed in an alternate method of installing a covered fingerprint sensor assembly into a host device panel are described below with reference to FIG. 2:

A host device panel 103 for a host device 104 is manufactured with a hole of appropriate dimensions and position in which a fingerprint sensor assembly 101 will ultimately be placed. In an embodiment, glass used for the host device panel 103 is strengthened glass of appropriate thickness and properties required to meet mechanical robustness requirements, such as 0.55 mm to 0.7 mm Corning Gorilla® Glass.

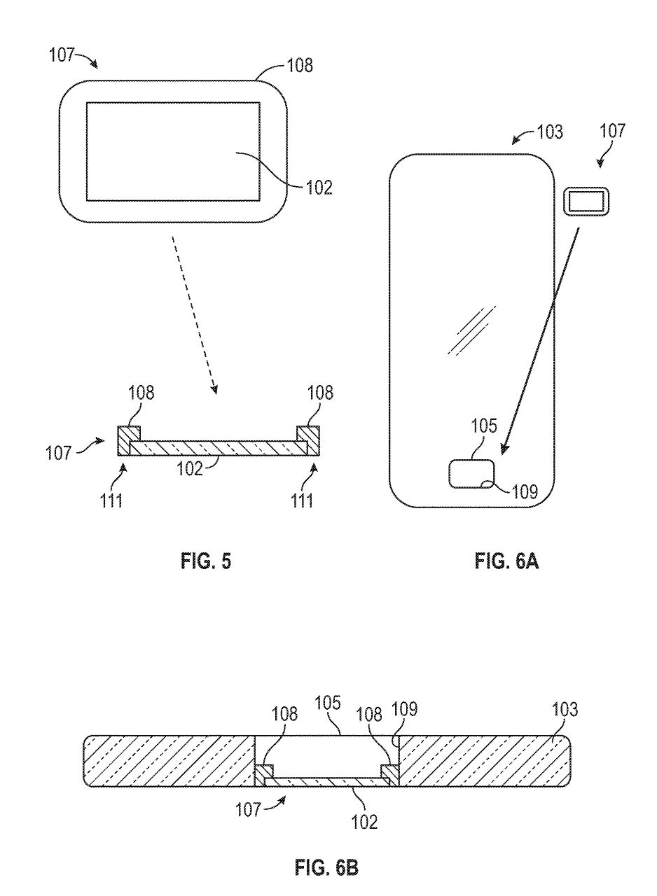

A suitable glass cover member 102 is placed into the hole (secured within the hole as shown in FIG. 2) in the host device panel 103, and the cover member 102 and the host device panel 103 are bonded together with a molding process described as follows and illustrated in FIGS. 5-8. The process described in conjunction with FIGS. 6A and 6B refers to a molded cover member 107, which is a cover member 102 with a molding compound 108 secured to peripheral edges thereof. Co-owned patent application entitled “Method of manufacturing a cover member suitable for a fingerprint sensor,” Provisional Application No. 62/382,884, the disclosure of which is hereby incorporated by reference, describes a process and exemplary materials for forming a molded cover member. It should be noted, however, that the process described herein may be employed with a non-molded cover member, i.e., a cover member having no molding compounded secured to peripheral edges thereof.

In various embodiments, the thickness of the glass cover member 102 may be 70-140 μm.

The cover member 102 may be sized for a slight interference fit to the hole 105 in the host device panel 103. Alternatively, the cover member 102 can be sized to be slightly undersized to the hole 105 in the host device panel 103, e.g., 10-25 μm smaller, such that within the typical tolerances for the cover member 102 outer dimension(s), some percentage of the cover members result in an interference fit. The cover member 102 may be a different thickness than the host device panel 103 and may be a different “type” of material, e.g., different type of glass, in terms of its physical properties, color, translucency, roughness, dielectric properties, etc.

FIG. 8 shows a flow chart of the steps for installing the molded cover member 107 into the panel 103.

Step 112. Apply adhesive (e.g., UV curable) to inner diameter 109 of the hole 105, or “cover glass ‘CG’ opening” (i.e., to the edges of the hole 105) in the host device panel 103. The term “diameter” should not be construed as requiring a circular hole, as the hole may be rectangular or any other shape.

Step 113a or 113b. Maintain host device panel 103 at ambient temperature (step 113a) or at elevated temperature to expand the hole 105 (step 113b).

Step 114. Rapid-cool the molded cover member 107 to shrink the outer dimension 111 (shown in FIG. 5) of the cover member 107.

Step 115. Referring to FIG. 6B (and 10A and 10B), optically align and insert the shrunken, molded cover member 107 into the hole 105 in the host device panel 103.

Steps 116, 117. Warm the cover member 107 in Step 116 to room temperature and cool the host device panel 103 (if the host device panel had been heated above ambient temperature in step 113b), and subsequently cure the adhesive in Step 117; for example, by exposing the adhesive to appropriate UV energy to UV cure a UV curable adhesive. Other types of adhesives can be used, such as snap cure epoxies or cyanoacrylate adhesives. In one embodiment, the molding compound 108 on the molded cover member 107 may be a compliant material that can compress to accommodate a tight fit between the cover member 107 and the opening in the host device panel 105, such as an elastomer. The molding compound 108 may also be conductive.

Step 118. Insert fingerprint sensor assembly 101 in the hole in the host device panel 103 under the cover member 102, and bond the fingerprint sensor assembly 101 to the cover member 102. Suitable fingerprint sensor assemblies and bonding techniques include, but are not limited to, those described in U.S. Patent Application Publication No. 2017/0147852 and U.S. patent application Ser. No. 15/628,003.

Step 119. Dispense adhesive or inject molding compound to encapsulate any gap between the fingerprint sensor assembly 101 and the host device panel 103 and sensor cover member 102, if desired, to make the structure more robust.

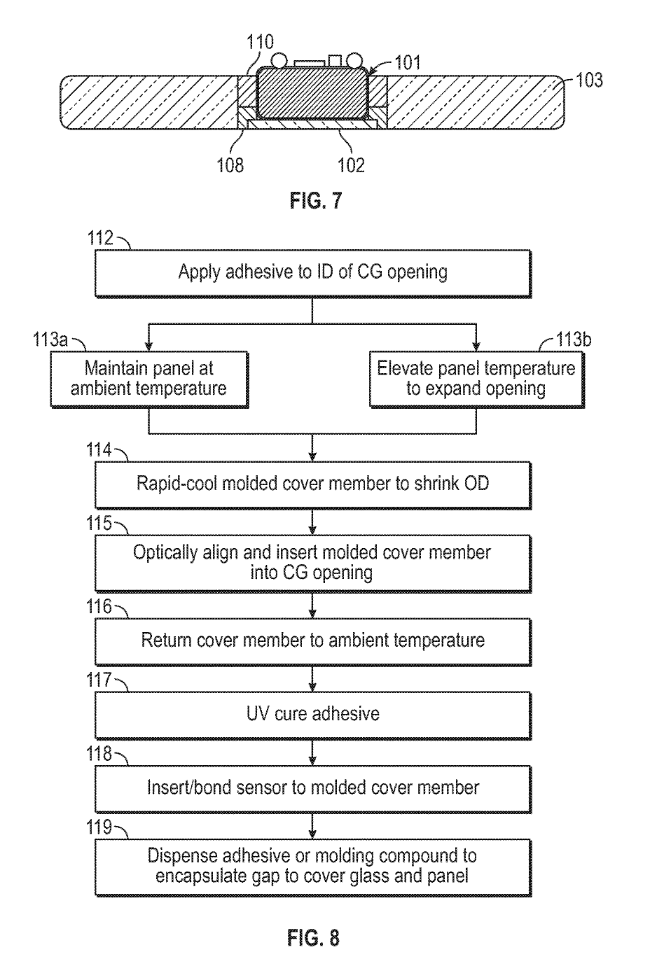

If not done in a previous step, optionally, the fingerprint sensor assembly 101 is incorporated into a pre-manufactured spacer frame 110 edgewise surrounding the fingerprint sensor assembly 101 (see FIG. 7) as described, for example, in U.S. Patent Application Publication No. 2017/0147852. If a spacer frame is not used, reference number 110 in FIG. 7 may represent molding compound injected to encapsulate any gap between the fingerprint sensor assembly 101 and the host device panel 103 and sensor cover member 102.

If not done in a previous step, optionally, a suitable reinforcement panel (not shown) is adhered to the surface of the fingerprint sensor 101 and/or the cover member 102 as described, for example, in U.S. patent application Ser. No. 15/628,003.

The sensor assembly 101 is adhered to the host device panel 103 that incorporates the cover member 102 in such a way that the cover member 102 fits over the sensor assembly 101.

Appropriate I/O connections are made to connect the fingerprint sensor assembly 101 to the device 104 and the host device panel 103 is fixed in place. For example, a flex tail (e.g. a flexible substrate, such as a polyimide film, with conductive traces extending from the sensor assembly), including connectors for making I/O connections between the fingerprint sensor assembly 101 and the host device 104, may be attached to the sensor 101, such as by soldering using ball grid array interconnections. Alternatively, the sensor assembly 101 may have an integral flex tail, whereby the flex tail and the wrapped flexible circuit subassembly comprise a unitary circuit element such as where the flex tail is an extension or continuation of the flexible circuit subassembly (e.g., as described in U.S. Patent Application Publication No. 2017-0147852), and which has a separable connector at the end of it which can subsequently be connected to the host device, such as to the host device main logic board.

The steps described above may take place in a different order.

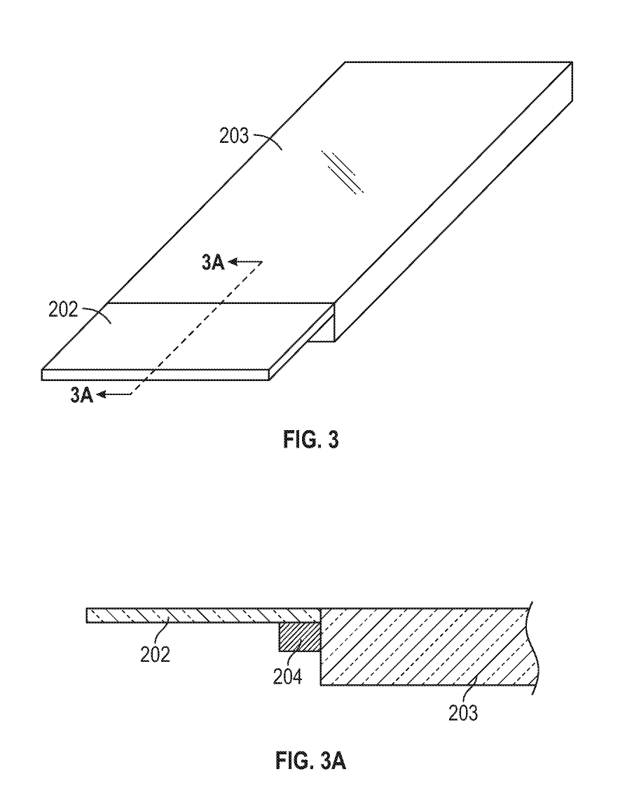

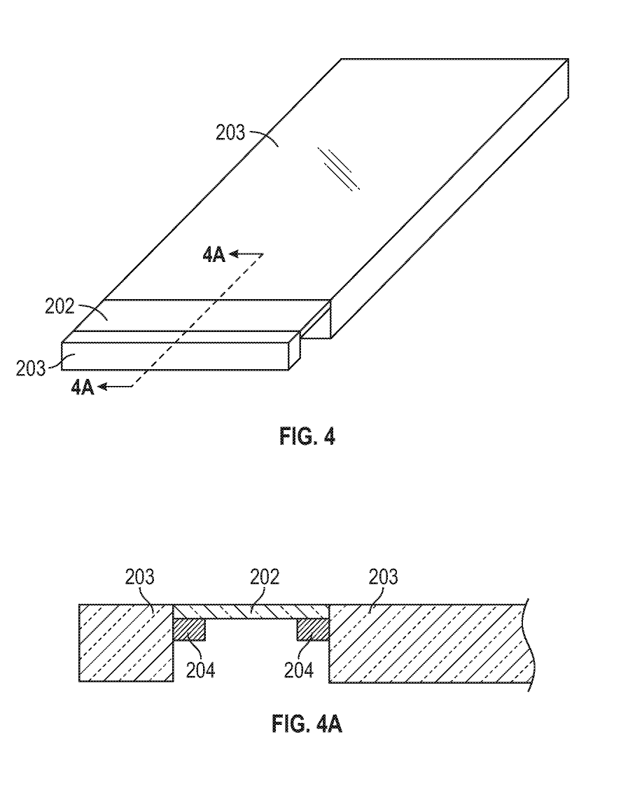

In an alternate embodiment, as shown in FIGS. 3 and 4, the cover member 202 may be a strip of glass that is bonded edge-to-edge with the host device panel 203, rather than being placed in a hole formed in the host device panel. (The sensor assembly is omitted from FIGS. 3 and 4 for simplicity.) Note that FIGS. 3 and 4 are intended to be schematic diagrams and are not intended to show all practical details of a typical installation, which may further include a supporting structure 204 for the cover member 202, such as a ledge on which the cover member 202 is supported (See FIGS. 3A and 4A), and a supporting member that may comprise a high dielectric constant ceramic or composite material.

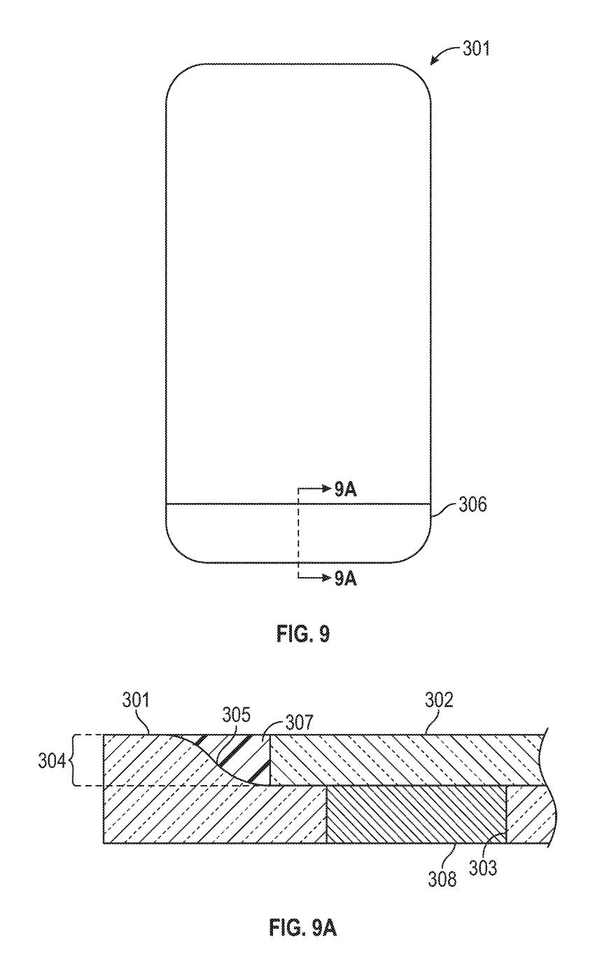

FIGS. 9 and 9A show an alternative, exemplary embodiment whereby a strip cover member is bonded to a thinned or recessed area of the host device panel in which there is an opening for the fingerprint sensor assembly. The opening for the fingerprint sensor assembly may be a through hole or a blind hole.

As shown in FIGS. 9 and 9A, a lower portion 306 of the host device panel 301 at the bottom of the host device (e.g., a phone) may be an inactive area that is recessed, e.g., by etching to reduce thickness by approximately 100 μm, to form a recess 304. The inactive area 306 is a part of the host device panel 301 that is non-functional, e.g., it does not function as a display and/or input (e.g., touch screen) device. A cover member 302 has the size and shape of the full, recessed inactive area of the host device panel 301 at the bottom of, for example, a phone. The cover member may be colored, e.g., black, to match the inactive area 306. An opening 303 is provided in the host device panel 301 in the inactive area 306 for insertion of the fingerprint sensor assembly, and the whole recessed area 304, including the opening 303 and a fingerprint sensor assembly 308 disposed therein, is covered by the cover member 302. The cover member 302 is bonded to the host device panel 301 and any gap around the sensor assembly may be filled (e.g., with epoxy, molding compound, etc.) to fully support the cover member 302. The sensor assembly 308 may be bonded to the cover member 302 and/or the host device panel 301 through the opening 303 in the host device panel 301.

As it may be impractical to achieve an instantaneous change in thickness between the recessed and non-recessed portions of the host device panel, there may be a transition area 305 between the edge of the cover member 302 and the edge of the recessed (etched) area 304 of the host device panel 301. This transition area 305 may be filled with a filler material 307, such as a colored or non-colored epoxy, molding compound, etc.

An installation as shown in FIG. 4 would have two transition areas to fill with epoxy, one at each edge of the cover member 202 that faces a part of the host device panel 203.

The installation of FIGS. 9 and 9A need not be made in an inactive area or at a bottom portion of the host device panel. That is, the installation shown in FIGS. 9 and 9A may alternatively be incorporated into an active area of the host device panel (e.g., a portion of the host device panel that functions as a display and/or input (e.g., touch screen) device) and/or the installation may be incorporated into any other portion of the host device panel (e.g., top, side, middle) at which a fingerprint sensor is desired.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. A method for incorporating a fingerprint sensor assembly into a glass panel of a host device, the method comprising:
forming a recess in the host device panel;
placing a cover member into the hole and securing the glass cover member in the hole with securing material;
placing a fingerprint sensor assembly within the hole, under the glass cover member; and
securing the fingerprint sensor assembly within the hole.

2. The method of claim 1, wherein securing the cover member in the hole comprises cooling the cover member to reduce an out dimension thereof and placing the cooled cover member into the hole.

3. The method of claim 1, wherein securing the glass cover member in the hole comprises elevating the temperature of the host device panel to expand the hole and placing the cover member into the hole.

4. The method of claim 1, further comprising applying the securing material to the edge of the hole prior to placing the cover member into the hole.

5. The method of claim 1, wherein the securing material comprises an adhesive.

6. The method of claim 4, wherein the adhesive comprises a UV curable adhesive, a snap cure epoxy, or a cyanoacrylate adhesive.

7. The method of claim 1, wherein the fingerprint sensor assembly is incorporated into a spacer frame edgewise surrounding the fingerprint sensor assembly.

8. The method of claim 1, wherein the cover member is flush mounted or recess mounted into a glass panel of a host device.

9. The method of claim 1, wherein the cover member is made from glass.

10. The method of claim 1, wherein the cover member is flush with, recessed below, or projecting above a surface of the host device panel.

11. A method for incorporating a fingerprint sensor assembly into a glass panel of a host device, the method comprising:
forming a recessed area in the host device panel;
forming an opening in the host device panel within the recessed area, wherein the size of the opening is smaller than the size of the recessed area;
placing a fingerprint sensor assembly within the opening; and
placing a cover member over the recessed area and the opening, and securing the glass cover member to the host device panel with securing material.

12. The method of claim 11, further comprising applying the securing material to the edge of the opening prior to placing the cover member into the hole.

13. The method of claim 12, wherein the securing material comprises an adhesive.

14. The method of claim 13, wherein the adhesive comprises a UV curable adhesive, a snap cure epoxy, or a cyanoacrylate adhesive.

15. The method of claim 11, wherein the cover member is made from glass.

16. The method of claim 11, wherein the cover member is flush with, recessed below, or projecting above a surface of the host device panel.

17. A method for incorporating a fingerprint sensor assembly into a glass panel of a host device, the method comprising:
adhering a cover member to a surface of the fingerprint sensor assembly to form a covered fingerprint sensor assembly;
operatively connecting the fingerprint sensor assembly to the host device;
placing a glass panel over a portion of the host device, the glass panel having a hole formed therein to receive the covered fingerprint sensor assembly with an outer surface of the cover member exposed through the hole; and
securing the covered fingerprint sensor assembly within the hole.

18. The method of claim 17, wherein the cover member is made from glass.

19. The method of claim 17, wherein securing the covered fingerprint sensor assembly within the hole comprises dispensing an adhesive into a gap between the perimeter of the hole and the cover member.

20. The method of claim 17, wherein securing the covered fingerprint sensor assembly within the hole comprises molding the covered fingerprint sensor assembly in place within the hole.
